(19) United States
(12) Patent Application Publication
(10) Pub. No.: US 2019/0070905 A1
(43) Pub. Date: Mar. 7, 2019

(54) NON-PNEUMATIC TIRE

(71) Applicant: TOYO TIRE & RUBBER CO., LTD., Itami-shi (JP)

(72) Inventor: Kohei Kajiwara, Itami-shi (JP)

(73) Assignee: TOYO TIRE & RUBBER CO., LTD., Itami-shi (JP)

(21) Appl. No.: 16/117,647

(22) Filed: Aug. 30, 2018

(30) Foreign Application Priority Data
Sep. 7, 2017 (JP) 2017-172044

(51) Int. Cl. B60C 7/18; B60B 9/26; B60B 9/08

(52) U.S. Cl. CPC B60C 7/18; B60C 2007/146; B60B 9/08; B60B 9/26

(57) ABSTRACT

A non-pneumatic tire includes a support structure for supporting a load from a vehicle. The support structure includes an inner annular portion, an outer annular portion concentrically provided outside the inner annular portion, and a plurality of connecting portions which connect the inner annular portion and the outer annular portion to each other and are provided in a tire circumferential direction independently of one another, and the plurality of connecting portions are configured such that elongated plate-like first connecting portions and elongated plate-like second connecting portions are arrayed along the tire circumferential direction, the first connecting portions being extended from one side in a tire width direction of the inner annular portion to other side in a tire width direction of the outer annular portion, and the second connecting portions being extended from other side.

### BACKGROUND OF THE INVENTION

### Field of the Invention

The present invention relates to a non-pneumatic tire provided with, as a tire structural member, a support structure for supporting a load from a vehicle. Preferably, the present invention relates to a non-pneumatic tire usable as a substitute for a pneumatic tire.

### Description of the Related Art

As conventional non-pneumatic tires, for example, there are a solid tire, a spring tire, a cushion tire, and the like. These non-pneumatic tires do not have excellent performance of a pneumatic tire.

Patent Document 1 describes a non-pneumatic tire, in which an annular outer circumferential member and an annular inner circumferential member are connected to each other by spokes, at least the spokes have spoke structures made of rubber or resin, and metal layers are attached to at least radial surfaces of the spokes. The metal layers are attached to the radial surfaces of the spokes, whereby radial rigidity of the spokes is increased to improve a load bearing capacity, and in addition, deformation of the tire at the time of rolling is suppressed as the load bearing capacity is improved. Therefore, heat generation can be reduced, and rolling resistance can be reduced.

Moreover, Patent Document 2 describes a non-pneumatic tire including: an inner annular portion; an outer annular portion provided concentrically on an outer side of the inner annular portion; and a plurality of connecting portions which connect the inner annular portion and the outer annular portion to each other and are provided independently of one another in a tire circumferential direction. The plurality of connecting portions are composed in such a manner that elongated plate-like first connecting portions and elongated plate-like second connecting portions are arrayed along the tire circumferential direction. The first connecting portions are extended from one side in a tire width direction of the inner annular portion to other side in a tire width direction of the outer annular portion. The second connecting portions are extended from other side in the tire width direction of the inner annular portion to one side in the tire width direction of the outer annular portion. On a side surface of each of the first connecting portions or each of the second connecting portions, at least one protrusion protruding in a direction intersecting the tire circumferential direction is formed along an extended direction of the first connecting portions or the second connecting portions. In the protrusion, a through-hole penetrating the protrusion in the tire circumferential direction is formed. Such a protrusion as described above is provided, whereby the first connecting portion or the second connecting portion is effectively cooled to improve durability.

In the non-pneumatic tire of Patent Document 1, due to repetitive strain, joint portions between the spokes and the outer circumferential member and joint portions between the spokes and the inner circumferential member are prone to be broken, and the durability of the non-pneumatic tire of Patent Document 1 is insufficient. Moreover, in the non-pneumatic tires having such spoke structures as disclosed in Patent Documents 1 and 2, force supporting external force differs between a case of grounding immediately under the spoke and a case of grounding under a portion between the spokes adjacent in the tire circumferential direction. Therefore, dispersion of a ground contact pressure during tire rolling tends to increase, causing a problem that a riding comfort is poor in comparison with a pneumatic tire.

### PRIOR ART DOCUMENTS

### Patent Documents

[Patent Document 1] JP-A-2008-132951

[Patent Document 2] JP-A-2017-7360

### SUMMARY OF THE INVENTION

Accordingly, it is an object of the present invention to provide a non-pneumatic tire capable of improving the durability and the riding comfort.

The above object can be achieved by the present invention as described below.

More specifically, a non-pneumatic tire according to the present invention is a non-pneumatic tire including a support structure for supporting a load from a vehicle, wherein the support structure includes an inner annular portion, an outer annular portion concentrically provided on an outer side of the inner annular portion, and a plurality of connecting portions which connect the inner annular portion and the outer annular portion to each other and are provided in a tire circumferential direction independently of one another, the plurality of connecting portions are configured such that elongated plate-like first connecting portions and elongated plate-like second connecting portions are arrayed along the tire circumferential direction, the first connecting portions being extended from one side in a tire width direction of the inner annular portion to other side in a tire width direction of the outer annular portion, and the second connecting portions being extended from other side in the tire width direction of the inner annular portion to one side in the tire width direction of the outer annular portion, and in each of the first connecting portions and the second connecting portions, a plate thickness is smaller than a plate width, and a plate thickness direction is oriented to the tire circumferential direction, and each of the first connecting portions and the second connecting portions when viewed in the tire circumferential direction includes a reinforcing portion on a tire radial direction inner end portion or a tire radial direction outer end portion, the reinforcing portion being made larger than a plate width of a tire radial direction center portion, and a sum of a surface area of the tire radial direction inner end portion and a surface area of the tire radial direction outer end portion including the reinforcing portion is equal to or larger than a surface area of the tire radial direction center portion.

In the present invention, the surface area of the tire radial direction outer end portion may be equal to or larger than the surface area of the tire radial direction inner end portion.

In the present invention, the reinforcing portion may have an arc shape.

In the present invention, the plate width of the tire radial direction center portion may be constant in the tire radial direction.

A non-pneumatic tire according to the present invention includes: an inner annular portion; an outer annular portion concentrically provided on an outer side of the inner annular portion; and a plurality of connecting portions connecting the inner annular portion and the outer annular portion to each other. The plurality of connecting portions are configured such that a plurality of first connecting portions and a plurality of second connecting portions are arrayed in a tire circumferential direction. The first connecting portions are extended from one side in a tire width direction of the inner annular portion to other side in a tire width direction of the outer annular portion, and the second connecting portions are extended from other side in the tire width direction of the inner annular portion to one side in the tire width direction of the outer annular portion. The first connecting portions and the second connecting portions have an elongated plate shape in which a plate thickness is smaller than a plate width, and a plate thickness direction is oriented to the tire circumferential direction. As a result, even if the plate thickness is thinned, the connecting portions can obtain desired rigidity by setting the plate width to be wide, and therefore, the durability can be improved. Moreover, by increasing the number of connecting portions while thinning the plate thickness, gaps between the connecting portions adjacent to one another in the tire circumferential direction can be reduced while maintaining the rigidity of the entire tire. Therefore, the dispersion of the ground contact pressure during the tire rolling can be reduced. Moreover, the first connecting portion and the second connecting portion when viewed in the tire circumferential direction include the reinforcing portions, which are made larger than the plate width of the tire radial direction center portion, on the tire radial direction inner end portion or the tire radial direction outer end portion. Accordingly, stress concentration at the tire radial direction inner end portion or the tire radial direction outer end portion, where the first connecting portion and the second connecting portion are coupled to the inner annular portion or the outer annular portion can be reduced, and the durability can be further improved.

### BRIEF DESCRIPTION OF THE DRAWINGS FIG.

FIG. 1 is a front view showing an example of a non-pneumatic tire of the present invention;

FIG. 2A is a cross-sectional view taken along a line A-A of the non-pneumatic tire of FIG. 1;

FIG. 2B is a perspective view showing a part of the non-pneumatic tire of FIG. 1;

FIG. 3 is a partially enlarged view of the non-pneumatic tire of FIG. 1;

FIG. 4 is a cross-sectional view showing a first connecting portion of FIG. 2A;

FIG. 5 is a tire meridian cross-sectional view of a non-pneumatic tire according to another embodiment;

FIG. 6 is a tire meridian cross-sectional view of a non-pneumatic tire according to another embodiment; and

FIG. 7 is a tire meridian cross-sectional view of a non-pneumatic tire according to a comparative example.

### DETAILED DESCRIPTION OF THE PREFERRED EMBODIMENTS

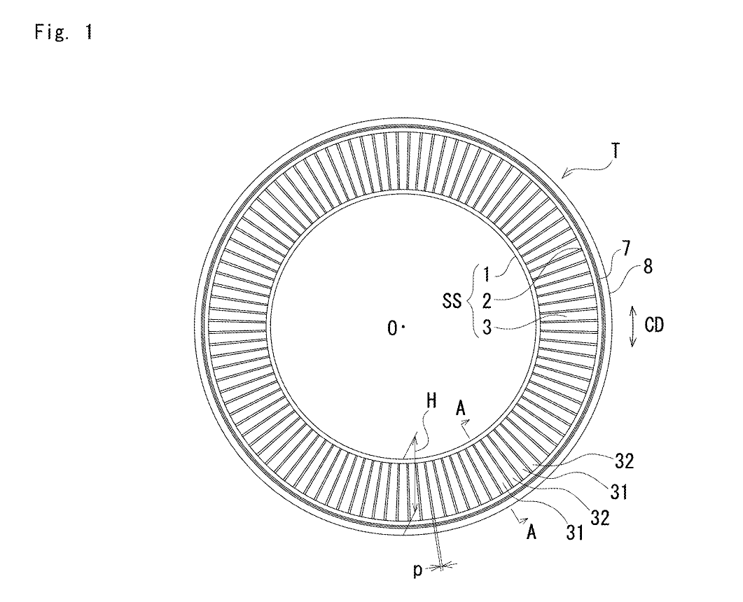

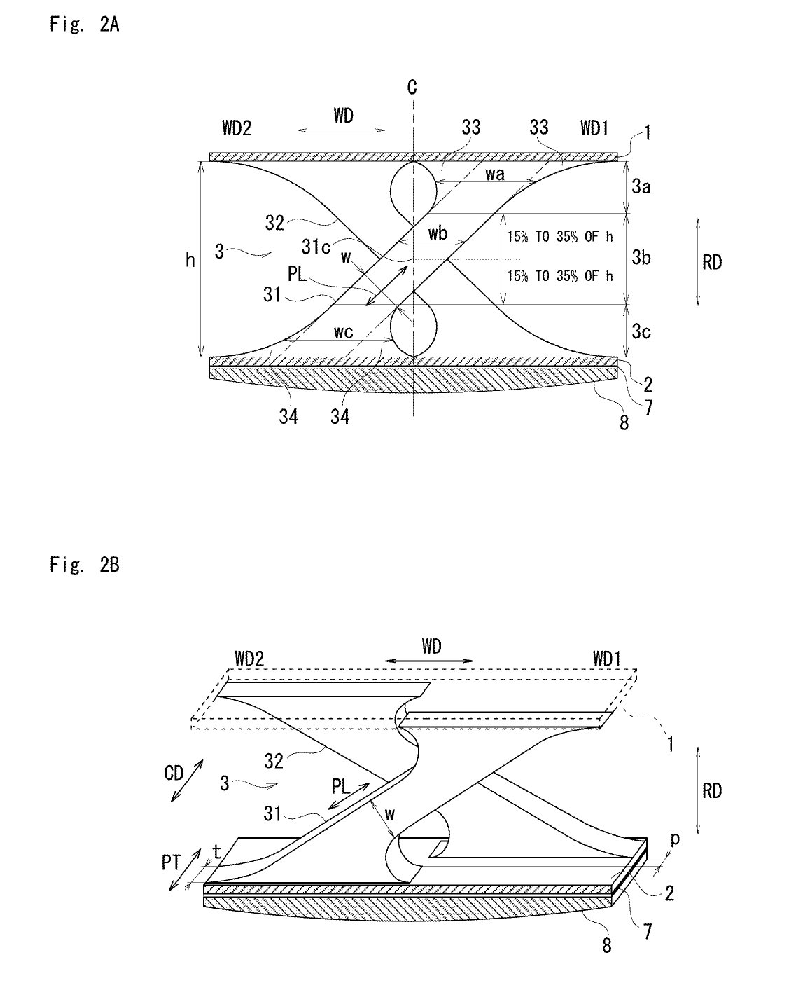

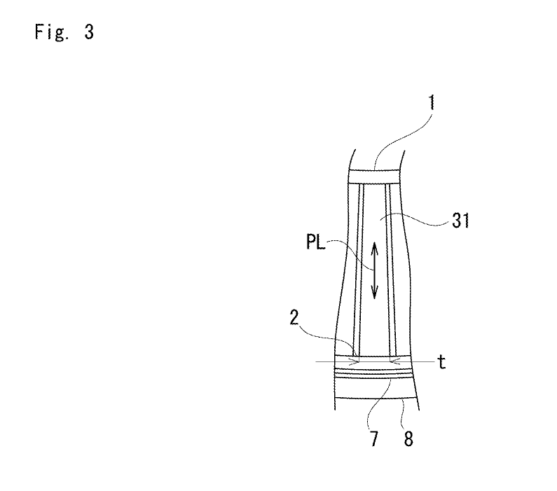

Hereinafter, embodiments of the present invention will be described with reference to the drawings. First, a configuration of a non-pneumatic tire T of the present invention will be described. FIG. 1 is a front view showing an example of the non-pneumatic tire T. FIG. 2A is a cross-sectional view taken along a line A-A of FIG. 1, and FIG. 2B is a perspective view showing a part of the non-pneumatic tire. FIG. 3 is an enlarged view of a part of FIG. 1. Here, reference symbol O denotes an axis, and reference symbol H denotes a cross-sectional height of the tire.

The non-pneumatic tire T is provided with a support structure SS for supporting a load from a vehicle. The non-pneumatic tire T of the present invention just needs to be provided with such a support structure SS as described above. A member corresponding to the tread, a reinforcing layer, members for accommodation to an axle and a rim may be provided on an outer side (outer circumference side) and inner side (inner circumference side) of the support structure SS.

As shown in the front view of FIG. 1, in the non-pneumatic tire T of this embodiment the support structure SS includes: an inner annular portion 1; an outer annular portion 2 provided concentrically on an outer side of the inner annular portion 1; and a plurality of connecting portions 3 which connect the inner annular portion 1 and the outer annular portion 2 to each other and are provided independently of one another in a tire circumferential direction CD.

From a viewpoint of improving uniformity, it is preferable that the inner annular portion 1 have a cylindrical shape with a constant thickness. Moreover, on an inner circumferential surface of the inner annular portion 1, it is preferable to provide irregularities and the like for maintaining fitting property in order to mount the non-pneumatic tire T to the axle and the rim.

The thickness of the inner annular portion 1 is preferably 2 to 10% of the cross-sectional height H of the tire, more preferably 3 to 9% thereof from a viewpoint of achieving weight reduction and improvement of durability while sufficiently transmitting force to the connecting portions 3.

An inner diameter of the inner annular portion 1 is appropriately determined according to dimensions of the rim and the axle on which the non-pneumatic tire T is to be mounted, and the like. However, when substitution for a general pneumatic tire is assumed, the inner diameter is preferably 250 to 500 mm, more preferably 320 to 440 mm.

A width of the inner annular portion 1 in a tire width direction is appropriately determined depending on a purpose, a length of the axle, and the like. However, when the substitution for a general pneumatic tire is assumed, the width is preferably 100 to 300 mm, more preferably 120 to 250 mm.

A tensile modulus of the inner annular portion 1 is preferably 5 to 180,000 MPa, more preferably 7 to 50,000 MPa from a viewpoint of achieving the weight reduction, the improvement of the durability and mounting easiness while sufficiently transmitting a force to the connecting portions 3. The tensile modulus in the present invention is a value calculated from a tensile stress at 10% elongation after conducting a tensile test according to JIS K7312.

The support structure SS in the present invention is formed of an elastic material. From a viewpoint of enabling integral molding at the time of manufacturing the support structure SS, it is preferable that the inner annular portion 1, the outer annular portion 2, and the connecting portion 3 be basically made of the same material except a reinforcing structure.

The elastic material in the present invention refers to a material in which the tensile modulus calculated from the tensile stress at 10% elongation after conducting the tensile test according to JIS K7312 is 100 MPa or less. In the elastic material of the present invention, the tensile modulus is preferably 5 to 100 MPa, more preferably 7 to 50 MPa from a viewpoint of imparting appropriate rigidity while obtaining sufficient durability. Examples of the elastic material used as abase material include thermoplastic elastomer, crosslinked rubber, and other resins.

Examples of the thermoplastic elastomer include polyester elastomer, polyolefin elastomer, polyamide elastomer, polystyrene elastomer, polyvinyl chloride elastomer, and polyurethane elastomer. Examples of a rubber material that composes the crosslinked rubber material include not only natural rubber but also synthetic rubber such as styrene butadiene rubber (SBR), butadiene rubber (BR), isoprene rubber (IIR), nitrile rubber (NBR), hydrogenated nitrile rubber (hydrogenated NBR), chloroprene rubber (CR), ethylene propylene rubber (EPDM), fluororubber, silicone rubber, acrylic rubber, and urethane rubber. Two or more of these rubber materials may be used in combination according to needs.

Examples of other resins include thermoplastic resin and thermosetting resin. Examples of the thermoplastic resin include polyethylene resin, polystyrene resin, and polyvinyl chloride resin. Examples of the thermosetting resin include epoxy resin, phenol resin, polyurethane resin, silicone resin, polyimide resin, and melamine resin.

Among the above elastic materials, the polyurethane resin is preferably used from viewpoints of moldability and processability and cost. As the elastic material, a foamed material may be used, and those obtained by foaming the above thermoplastic elastomer, crosslinked rubber, and other resins are usable.

In the support structure SS integrally molded with the elastic material, it is preferable that the inner annular portion 1, the outer annular portion 2, and the connecting portions 3 be reinforced by reinforcing fiber.

Examples of the reinforcing fiber include reinforcing fibers such as long fiber, short fiber, woven fabric, and nonwoven fabric. However, as a mode of using the long fiber, it is preferable to use net-like fiber aggregate composed of pieces of fiber, which are arrayed in the tire width direction, and of pieces of fiber, which are arrayed in the tire circumferential direction.

Examples of the reinforcing fiber include a rayon cord, a polyamide cord such as nylon-6,6, a polyester cord such as polyethylene terephthalate, an aramid cord, a glass fiber cord, a carbon fiber, and a steel cord.

In the present invention, in addition to the reinforcement using the reinforcing fiber, it is possible to perform reinforcement using a granular filler or reinforcement using a metal ring or the like. Examples of the granular filler include carbon black, silica, ceramics such as alumina, and other inorganic fillers.

From the viewpoint of improving the uniformity, it is preferable that the outer annular portion 2 have a cylindrical shape with a constant thickness. The thickness of the outer annular portion 2 is preferably 2 to 20% of the cross-sectional height H of the tire, more preferably 10 to 15% thereof from the viewpoint of achieving the weight reduction and the improvement of the durability while sufficiently transmitting force from the connecting portions 3.

An inner diameter of the outer annular portion 2 is appropriately determined depending on a purpose and the like. However, when the substitution for a general pneumatic tire is considered, the inner diameter is preferably 420 to 750 mm, more preferably 470 to 680 mm.

A width of the outer annular portion 2 in the tire width direction is appropriately determined depending on the purpose and the like. However, when the substitution for a general pneumatic tire is considered, the width is preferably 100 to 300 mm, more preferably 120 to 250 mm.

When a reinforcing layer 7 is provided on an outer circumference of the outer annular portion 2 as shown in FIG. 1, the tensile modulus of the outer annular portion 2 can be set to the same degree as the inner annular portion 1. When such a reinforcing layer 7 is not provided, the tensile modulus of the outer annular portion 2 is preferably 5 to 180,000 MPa, more preferably 7 to 50,000 MPa from a viewpoint of achieving the weight reduction and the improvement of the durability while sufficiently transmitting the force from the connecting portions 3.

When increasing the tensile modulus of the outer annular portion 2, a fiber-reinforced material in which an elastic material is reinforced by fiber and the like is preferably used. By reinforcing the outer annular portion 2 by reinforcing fiber, the outer annular portion 2 is also sufficiently adhered to a belt layer and the like.

The connecting portions 3 connect the inner annular portion 1 and the outer annular portion 2 to each other. The connecting portions 3 are plural and provided independently of one another in the tire circumferential direction CD at appropriate intervals between the inner annular portion 1 and the outer annular portion 2.

The plural connecting portions 3 are configured such that first connecting portions 31 and second connecting portions 32 are arrayed along the tire circumferential direction CD. In this case, it is preferable that the first connecting portions 31 and the second connecting portions 32 are arrayed alternately with each other along the tire circumferential direction CD. This makes it possible to further reduce the dispersion of the ground contact pressure during the tire rolling.

From the viewpoint of improving the uniformity, it is preferable that a pitch p in the tire circumferential direction CD between each of the first connecting portions 31 and each of the second connecting portions 32 be set constant. The pitch p is preferably 0 to 10 mm, more preferably 0 to 5 mm. When the pitch p is larger than 10 mm, the ground contact pressure becomes uneven, which may cause noise to increase.

Each of the first connecting portions 31 is extended from one side WD1 in the tire width direction of the inner annular portion 1 toward other side WD2 in the tire width direction of the outer annular portion 2. Meanwhile, each of the second connecting portions 32 is extended from the other side WD2 in the tire width direction of the inner annular portion 1 toward one side WD1 in the tire width direction of the outer annular portion 2. That is, the first connecting portion 31 and the second connecting portion 32, which are adjacent to each other, are disposed in a substantially X shape when viewed in the tire circumferential direction CD.

The first connecting portion 31 and the second connecting portion 32 when viewed in the tire circumferential direction CD are preferably symmetric to each other with respect to a tire equatorial plane C as shown in FIG. 2A. Therefore, hereinafter, the first connecting portion 31 will mainly be described.

The first connecting portion 31 has an elongated plate-like shape extending from the inner annular portion 1 to the outer annular portion 2. In the first connecting portion 31, a plate thickness t is smaller than a plate width w, and a plate thickness direction PT is oriented to the tire circumferential direction CD. That is, the first connecting portion 31 has a plate shape extending in a tire radial direction RD and in a tire width direction WD. The first connecting portion 31 and the second connecting portion 32 are formed into such an elongated plate shape. In this way, even if the plate thickness t is reduced, the first connecting portion 31 and the second connecting portion 32 can obtain desired rigidity by setting the plate width w to be wide. Therefore, the durability can be improved. Moreover, the number of first connecting portions 31 and the number of second connecting portions 32 are increased while thinning the plate thickness t. In this way, gaps between the connecting portions adjacent to one another in the tire circumferential direction CD can be reduced while maintaining the rigidity of the entire tire. Therefore, the dispersion of the ground contact pressure during the tire rolling can be reduced.

The plate thickness t of the first connecting portion 31 may be constant along a longitudinal direction PL. However, as shown in FIG. 3, it is preferable that the plate thickness t of the first connecting portion 31 gradually increase from the inner annular portion 1 to the outer annular portion 2. In this case, the plate thickness t at the tire radial direction outer end of the first connecting portion 31 is set to be smaller than the plate width w.

The plate thickness t is preferably from 8 to 30 mm, more preferably from 10 to 25 mm from the viewpoint of achieving the weight reduction and the improvement of the durability while sufficiently transmitting forces from the inner annular portion 1 and the outer annular portion 2.

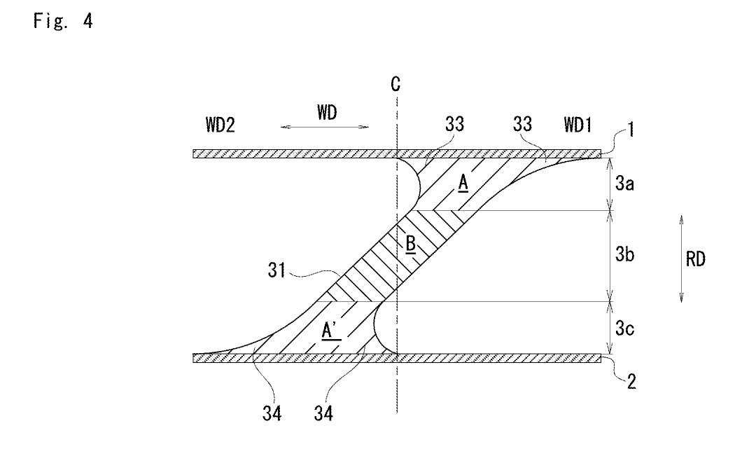

FIG. 4 shows only the first connecting portion 31 of FIG. 2A. The first connecting portion 31 is composed of a tire radial direction inner end portion 3a, a tire radial direction center portion 3b, and a tire radial direction outer end portion 3c. When a tire radial direction height of the first connecting portion 31 is h, the tire radial direction center portion 3b extends within a range of ±15 to 35% of h from a tire radial direction height center 31c of the first connecting portion 31 toward the tire radial direction RD.

In the tire radial direction center portion 3b, a plate width wb in the tire width direction WD is constant. Meanwhile, inner circumferential side reinforcing portions 33 made larger than the plate width wb of the tire radial direction center portion 3b are provided at the tire radial direction inner end portion 3a. In this way, at the tire radial direction inner end portion 3a, the plate width wa gradually increases toward the inside in the tire radial direction RD. The first connecting portion 31 when viewed in the tire circumferential direction includes the inner circumferential side reinforcing portions 33 made larger than the plate width wb of the tire radial direction center portion 3b at the tire radial direction inner end portion 3a. Accordingly, stress concentration at the tire radial direction inner end portion 3a where the first connecting portion 31 is coupled to the inner annular portion 1 can be reduced, and the durability can be further improved.

The inner circumferential side reinforcing portions 33 are provided individually on both sides of the first connecting portion 31 in the tire width direction WD. The inner circumferential side reinforcing portion 33 on the inner side in the tire width direction WD reaches the tire equatorial plane C. Moreover, the inner circumferential side reinforcing portion 33 on the outer side in the tire width direction WD reaches an end of the one side WD1 in the tire width direction of the non-pneumatic tire T.

A surface area A of the tire radial direction inner end portion 3a including the inner circumferential side reinforcing portions 33 is 0.5 times or more a surface area B of the tire radial direction center portion 3b. If the surface area A is less than 0.5 times the surface area B, the stress concentration at the tire radial direction inner end portion 3a may be a problem.

Outer circumferential side reinforcing portions 34 made larger than the plate width wb of the tire radial direction center portion 3b are provided at the tire radial direction outer end portion 3c. In this way, at the tire radial direction outer end portion 3c, the plate width we gradually increases toward the outside in the tire radial direction RD. The first connecting portion 31 when viewed in the tire circumferential direction includes the outer circumferential side reinforcing portions 34 made larger than the plate width wb of the tire radial direction center portion 3b at the tire radial direction outer end portion 3c. Accordingly, stress concentration at the tire radial direction outer end portion 3c where the first connecting portion 31 is coupled to the outer annular portion 2 can be reduced, and the durability can be further improved.

The outer circumferential side reinforcing portions 34 are provided individually on both sides of the first connecting portion 31 in the tire width direction WD. The outer circumferential side reinforcing portion 34 on the inner side in the tire width direction WD reaches the tire equatorial plane C. Moreover, the outer circumferential side reinforcing portion 34 on the outer side in the tire width direction WD reaches an end of the other side WD2 in the tire width direction of the non-pneumatic tire T.

A surface area A′ of the tire radial direction outer end portion 3c including the outer circumferential side reinforcing portions 34 is 0.5 times or more the surface area B of the tire radial direction center portion 3b. If the surface area A′ is less than 0.5 times the surface area B, the stress concentration at the tire radial direction outer end portion 3c may be a problem. Moreover, in this embodiment, the surface area A′ of the tire radial direction outer end portion 3c is equal to the surface area A of the tire radial direction inner end portion 3a.

A sum of the surface area A of the tire radial direction inner end portion 3a and the surface area A′ of the tire radial direction outer end portion 3c is equal to or larger than the surface area B of the tire radial direction center portion 3b. In this way, the stress concentration at the tire radial direction inner end portion 3a and the tire radial direction outer end portion 3c can be effectively reduced. Moreover, when a balance between the durability and the riding comfort is taken into consideration, it is preferable that the sum of the surface area A of the tire radial direction inner end portion 3a and the surface area A′ of the tire radial direction outer end portion 3c be twice or less the surface area B of the tire radial direction center portion 3b.

Both of the inner circumferential side reinforcing portions 33 and the outer circumferential side reinforcing portions 34 have an arc shape. Arcs of the inner circumferential side reinforcing portions 33 and the outer circumferential side reinforcing portions 34 protrude toward the first connecting portion 31 side. A curvature radius of the arcs is preferably 5 to 200 mm.

The plate width w is preferably from 5 to 25 mm, more preferably from 10 to 20 mm from the viewpoint of achieving the weight reduction and the improvement of the durability while sufficiently transmitting the forces from the inner annular portion 1 and the outer annular portion 2. Moreover, the plate width w is preferably 110% or more of the plate thickness t, more preferably 115% or more thereof from a viewpoint of reducing the dispersion of the ground contact pressure while improving the durability.

The plate width wa of the tire radial direction inner end portion 3a is preferably 30 to 140 mm, more preferably 70 to 140 mm. Moreover, the plate width wb of the tire radial direction center portion 3b is preferably 5 to 70 mm, more preferably 15 to 35 mm. Furthermore, the plate width we of the tire radial direction outer end portion 3c is preferably 30 to 140 mm, more preferably 70 to 140 mm.

The number of the connecting portions 3 is preferably 80 to 300, more preferably 100 to 200 from a viewpoint of achieving the weight reduction, improvement of power transmission and the durability while sufficiently supporting the load from the vehicle. FIG. 1 shows an example in which 50 pieces of the first connecting portions 31 and 50 pieces of the second connecting portions 32 are provided.

A tensile modulus of the connecting portion 3 is preferably 5 to 180,000 MPa, more preferably 7 to 50,000 MPa from a viewpoint of achieving the weight reduction, the improvement of the durability and improvement of lateral rigidity while sufficiently transmitting the forces from the inner annular portion 1 and the outer annular portion 2. When increasing the tensile modulus of the connecting portion 3, a fiber-reinforced material in which an elastic material is reinforced by fiber and the like is preferably used.

In this embodiment, as shown in FIG. 1, there is shown an example in which the reinforcing layer 7 for making reinforcement against bending deformation of the outer annular portion 2 of the support structure SS is provided outside the outer annular portion 2. Moreover, in this embodiment, as shown in FIG. 1, an example in which a tread 8 is provided further outside the reinforcing layer 7 is shown. As the reinforcing layer 7 and the tread 8, it is possible to provide similar ones to a belt layer and a tread of the conventional pneumatic tire. The tread 8 may be made of resin. Further, as the tread pattern, it is possible to provide a similar pattern to the conventional pneumatic tire.

In the present invention, it is preferable to further dispose a width direction reinforcing layer for increasing the rigidity in the tire width direction between the tire radial direction outer end of the connecting portion 3 and the tread 8. This suppresses buckling at a tire width direction center portion of the outer annular portion 2 and makes it possible to further improve the durability of the connecting portions 3. The width direction reinforcing layer is buried in the outer annular portion 2 or disposed outside the outer annular portion 2. Examples of the width direction reinforcing layer include a stuff in which steel cords or cords made of fiber reinforced plastics such as carbon fiber reinforced plastics (CFRP) and glass fiber reinforced plastics (GFRP) are arrayed substantially parallel to the tire width direction, a cylindrical metal ring, and a cylindrical high-modulus resin ring.

### Other Embodiment

(1) In the embodiment mentioned above, the surface area A′ of the tire radial direction outer end portion 3c is equal to the surface area A of the tire radial direction inner end portion 3a. However, preferably, the surface area A′ of the tire radial direction outer end portion 3c is equal to or larger than the surface area A of the tire radial direction inner end portion 3a. In this way, the ground contact pressure when the tire radial direction outer end portion 3c is grounded can be reduced, and the dispersion of the ground contact pressure is reduced. Accordingly, the riding comfort and the durability can be improved.

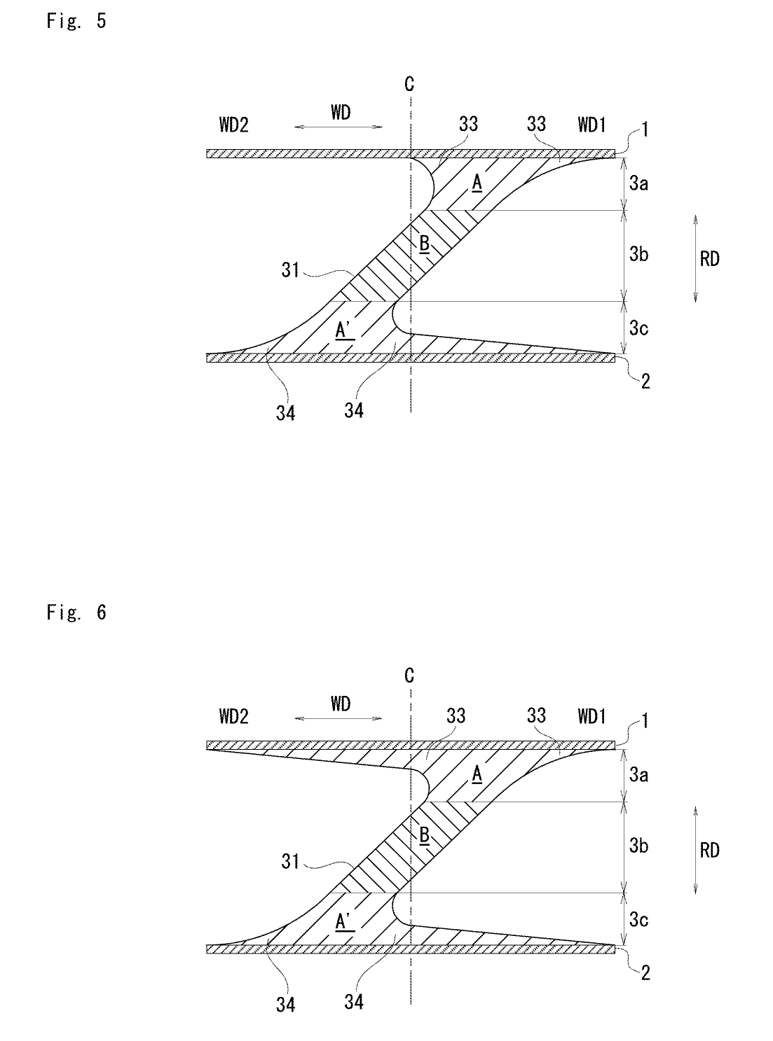

In an example shown in FIG. 5, the outer circumferential side reinforcing portion 34 on the inner side in the tire width direction WD extends beyond the tire equatorial plane C and reaches the end of such a tire width direction one side WD1 of the outer annular portion 2. In this way, the tire radial direction outer end portion 3c of the first connecting portion 31 is coupled to the outer annular portion 2 over the entire tire width direction WD. Note that the outer circumferential side reinforcing portion 34 on the inner side in the tire width direction WD does not necessarily reach the end of the tire width direction one side WD1 of the outer annular portion 2.

(2) Moreover, as shown in FIG. 6, the inner circumferential side reinforcing portion 33 on the inner side in the tire width direction WD may extend beyond the tire equatorial plane C and may reach the end of such a tire width direction other side WD2 of the inner annular portion 1. Note that the inner circumferential side reinforcing portion 33 on the inner side in the tire width direction WD does not necessarily reach the end of the tire width direction other side WD2 of the inner annular portion 1.

### EXAMPLES

Examples and the like which specifically show the configuration and effect of the present invention will be described below. Evaluation items in Examples and the like were measured as follows.

(1) Durability

The durability was measured as follows by a drum testing machine in accordance with FMVSS 109. A test speed was set constant at 80 km/h, and a distance traveled until a failure occurred was measured while applying a load divided into four gradually increasing steps. The distance traveled is indicated by an index when a distance traveled in Comparative example is 100, and a larger value exhibits superior durability.

(2) Riding Comfort

Sensory evaluation was carried out comprehensively about a riding comfort in a test course when two people ride. The riding comfort is indicated as a degree of strength of pushing up and down in the vertical direction, the pushing being directly felt by an occupant through his/her body. It is evaluated that stronger pushing exhibits a worse riding comfort. The riding comfort is indicated by an index when a riding comfort in Comparative example is 100, and a larger value exhibits a superior riding comfort.

### Examples 1 to 3

Non-pneumatic tires, which include: first connecting portions having the shapes shown in FIGS. 4 to 6; and second connecting portions having shapes symmetric to the first connecting portions with respect to the tire equatorial plane, were set as Examples 1 to 3. Results of the durability and the riding comfort are shown in Table 1 in combination.

### Comparative Example

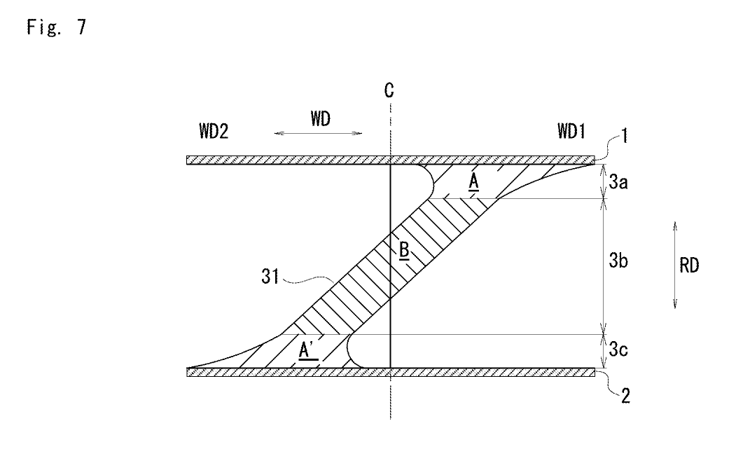

As shown in FIG. 7, Comparative example was set to have the same configuration as Example 1 except that a sum of the surface area of the tire radial direction inner end portion and the surface area of the tire radial direction outer end portion was made smaller than the surface area of the tire radial direction center portion. Results of the durability and the riding comfort are shown in Table 1 in combination.

TABLE 1

| | Comparative | | | |
|---|---|---|---|---|
| | Example | Example 1 | Example 2 | Example 3 |
| Shape of | FIG. 7 | FIG. 4 | FIG. 5 | FIG. 6 |
| connecting portion | | | | |
| Surface area | A = B × 0.4 | A = B × 0.98 | A = B × 0.98 | A = B × 1.20 |
| | A′ = B × 0.4 | A′ = B × 0.98 | A′ = B × 1.20 | A′ = B × 1.20 |
| Durability | 100 | 110 | 105 | 125 |
| Riding comfort | 100 | 130 | 150 | 105 |

From the results in Table 1, the following can be seen. The non-pneumatic tires of Examples 1 to 3 have improved durability and riding comfort as compared with Comparative example.

What is claimed is:

1. A non-pneumatic tire comprising a support structure for supporting a load from a vehicle,
wherein the support structure includes an inner annular portion, an outer annular portion concentrically provided on an outer side of the inner annular portion, and a plurality of connecting portions which connect the inner annular portion and the outer annular portion to each other and are provided in a tire circumferential direction independently of one another,
the plurality of connecting portions are configured such that elongated plate-like first connecting portions and elongated plate-like second connecting portions are arrayed along the tire circumferential direction, the first connecting portions being extended from one side in a tire width direction of the inner annular portion to other side in a tire width direction of the outer annular portion, and the second connecting portions being extended from other side in the tire width direction of the inner annular portion to one side in the tire width direction of the outer annular portion, and
in each of the first connecting portions and the second connecting portions, a plate thickness is smaller than a plate width, and a plate thickness direction is oriented to the tire circumferential direction, and
each of the first connecting portions and the second connecting portions when viewed in the tire circumferential direction includes a reinforcing portion on a tire radial direction inner end portion or a tire radial direction outer end portion, the reinforcing portion being made larger than a plate width of a tire radial direction center portion, and a sum of a surface area of the tire radial direction inner end portion and a surface area of the tire radial direction outer end portion including the reinforcing portion is equal to or larger than a surface area of the tire radial direction center portion.

2. The non-pneumatic tire according to claim 1, wherein the surface area of the tire radial direction outer end portion is equal to or larger than the surface area of the tire radial direction inner end portion.

3. The non-pneumatic tire according to claim 1, wherein the reinforcing portion has an arc shape.

4. The non-pneumatic tire according to claim 1, wherein the plate width of the tire radial direction center portion is constant in the tire radial direction.

5. The non-pneumatic tire according to claim 1, wherein, when a tire radial direction height of each of the first connecting portions is h, the tire radial direction center portion extends within a range of ±15 to 35% of h from a tire radial direction height center of each of the first connecting portions toward the tire radial direction.

6. The non-pneumatic tire according to claim 1, wherein the surface area of the tire radial direction inner end portion is 0.5 times or more the surface area of the tire radial direction center portion.

7. The non-pneumatic tire according to claim 1, wherein the surface area of the tire radial direction outer end portion is 0.5 times or more the surface area of the tire radial direction center portion.

8. The non-pneumatic tire according to claim 1, wherein a sum of the surface area of the tire radial direction inner end portion and the surface area of the tire radial direction outer end portion is twice or less the surface area of the tire radial direction center portion.

9. The non-pneumatic tire according to claim 1, wherein the reinforcing portion on the tire radial direction outer end portion of each of the first connecting portions reaches an end portion on one side in a tire width direction of the outer annular portion and an end portion on other side in the tire width direction of the outer annular portion.

10. The non-pneumatic tire according to claim 1, wherein the reinforcing portion on the tire radial direction inner end portion of each of the first connecting portions reaches an end portion on one side in a tire width direction of the inner annular portion and an end portion on other side in the tire width direction of the inner annular portion.
